(19) United States
(12) Patent Application Publication
(10) Pub. No.: US 2019/0242218 A1
(43) Pub. Date: Aug. 8, 2019

(54) ATTACHABLE LIGHTING SYSTEM FOR DRILLING RIG

(71) Applicant: APOLLO ENERGY SERVICES CORP., Crossfield (CA)

(72) Inventor: Matthew GOWANLOCK, Airdrie, Alberta (CA)

(73) Assignee: APOLLO ENERGY SERVICES CORP., Crossfield, AB (CA)

(21) Appl. No.: 16/320,122

(22) PCT Filed: Jul. 24, 2017
(86) PCT No.: PCT/IB2017/054478

§ 371 Date: Jan. 24, 2019

Related U.S. Application Data
(60) Provisional application No. 62/366,377, filed on Jul. 25, 2016.

(51) Int. Cl. E21B 41/00; F21S 8/04; F21V 21/116; F21V 21/30

(52) U.S. Cl. CPC E21B 41/0021; F21S 8/046; F21V 33/006; F21V 21/30; F21V 21/116

(57) ABSTRACT

A lighting system for a drilling rig including a lighting frame attachable to a crown of the drilling rig, wherein the lighting frame includes a fixed or adjustable frame portion attached to the crown of the drilling rig and a light bearing frame portion supported by the frame portion. Also provided is at least one light attached to the light bearing frame portion.

### CROSS-REFERENCE TO RELATED APPLICATIONS

This international application claims the benefit of U.S. Provisional Application Ser. No. 62/366,377, filed Jul. 25, 2016 which may relate to subject matter disclosed in one or more of U.S. Application Ser. No. 62/196,556, filed Jul. 24, 2015; Ser. No. 14/093,097, filed Nov. 29, 2013; Ser. No. 14/632,592, filed Feb. 26, 2015; Ser. No. 62/109,966, filed Jan. 30, 2015; and Ser. No. 62/127,020, filed Mar. 2, 2015. The entirety of each of the aforementioned applications is specifically incorporated herein by reference for all purposes.

### FIELD OF THE INVENTION

The present invention relates generally to the field of drilling apparatuses, such as oil drilling rig arrangements, and in particular to a lighting system for use on a drilling rig

### BACKGROUND OF THE INVENTION

Drilling rigs are used to form wellbores for the purpose of extracting oil, natural gas or other fluids from subsurface deposits. Drilling rigs can also be used for sampling subsurface mineral deposits, testing rock or ground fluid properties and for installing subsurface utilities, instrumentations, tunnels or wells. In implementation, drilling rigs may be mobile equipment transportable by truck, rail, trailers, or similar, rigs may also be semi-permanent and permanent fixtures as in the case for oil drilling of large wells. Marine-based structures are also widely known. Generally, the term drilling rig refers to an arrangement of equipment that is used to penetrate the subsurface of the earth's crust.

A conventional drilling rig 40 is illustrated in FIG. 4, where the drilling rig 40 includes a derrick 14, which provides a support structure for a majority of the equipment used to raise and lower drillstring 25 into and out of a wellbore. The drillstring 25 may be an assembled collection of drillpipe, drill collars, or any other assembled collection of assorted tools and equipment connected together and run into the wellbore to facilitate the drilling of a well. The drillstring 25 may be raised and lowered into and out of the wellbore by the draw-works 7, which includes a spool powered by a motor or other power source 5. A drill line 12, which may be a thick, stranded metal cable, is run through a travelling block 11. Typically, the crown block 13 remains stationary while travelling block 11 moves vertically with the drillstring 25. The combination of the crown block 13 and the travelling block 11 provides a significant mechanical advantage for lifting the drillstring 25. Further, a swivel 18 may be attached to the travelling block 11 to allow rotation of the drillstring 25 without twisting the travelling block 11. Drill pipes 16 and hole casing 26 are also shown.

The drilling rig 40 further includes a rotary table 20 mounted in a rig floor 21, which is used to rotate the drillstring 25 along with a kelly drive 19. Kelly drive 19, attached at an upper end to the swivel 18 and at a lower end to the drillstring 25, is inserted through the rotary table 20 to rotate the drillstring 25 (drillstring rotation shown by arrow “R”). Kelly drive 19 may be square, hexagonal, or any other polygonal-shaped tubing and is able to move freely vertically while the rotary table 20 rotates it. Alternatively, drilling rig 30 may include a top drive (not shown) in place of kelly drive 19 and rotary table 20. Additionally, blowout preventers (“BOPs”) may be located below the rig floor 21 and installed atop a wellhead 27 to prevent fluids and gases from escaping from the wellbore. An annular BOP 23 and one or more ram BOPs 24 are shown and are commonly understood in the art.

During drilling operations, drilling fluid may be circulated through the system to carry cuttings away from the bottom of the wellbore as drilling progresses. Drilling fluid may be stored in mud tanks 1 before being drawn through suction line 3 by mud pumps 4. Drilling fluid (drilling fluid route is indicated by arrows “F”) is then pumped from mud pumps 4 through a hose 6, up a stand pipe 8, through a flexible hose 9, and down into the wellbore. Drilling fluid returning from the wellbore is routed through a flow line 28 to shakers 2, which are used to separate drill cuttings from the drilling fluid before it is pumped back down the wellbore.

Drilling operations typically occur during daylight hours and visibility in and around the drilling rig has historically only been required when manual work is being done, inspection and calibration, for example. There is a desire to increase productivity by providing visibility during hours of low daylight, and this has thus far been accomplished by providing mobile lighting arrangements on vehicles proximate the drilling rig, or otherwise manually adding impromptu lighting arrangements.

These arrangements are inadequate and not readily adaptable to systematic visibility improvements in appropriate locations around a drilling rig.

### SUMMARY OF THE INVENTION

It is an object of the invention to improve upon one or more of the aforementioned deficiencies of the current systems. Accordingly, in one embodiment of the invention, there is provided a lighting system for a drilling rig including a lighting frame attached to the crown of the drilling rig, wherein the lighting frame includes a fixed or adjustable frame portion attached to the crown of the drilling rig and a light bearing frame portion supported by the frame portion shown, for example, in the Figures generally shown as two separate but connected frames, but can also optionally comprise one solid piece; and, in either case, at least one light fixture attached to the light bearing frame portion.

According to one embodiment, the frame portion is optionally extendable or fixed and includes at least four support posts for rigidly fixing the frame portion to the crown, and further includes, between at least two adjacent support posts, a first tubular load bearing member connected to one of the adjacent support posts; a second tubular load bearing member connected to the other of the adjacent support posts; an extendable or fixed frame member extending between and into each of the first and second tubular members;

According to another embodiment, the four support posts are arranged to form a generally rectangular shape.

According to another embodiment, the light bearing portion further comprises a plurality of light support posts spaced around a perimeter of the outer structural frame; the light support posts each comprising a first portion for attaching to the outer structural frame. The light support posts can be a permanent or removably attached, but as shown in the Figures are typically welded fixed connections in this embodiment; and a second portion fixture bracket or bracket(s) for holding the light.

According to another embodiment, each of the light support posts are adapted to hold at least one light fixtures.

According to another embodiment, the post holds at least two light fixtures spaced horizontally or vertically from each other.

According to another embodiment, each lighting fixture can swivel or tilt. It should be noted however, that since the light support post is in a fixed position, the bracket holding the light and/or the light itself, can swivel and/or tilt.

According to another embodiment of the invention, there is provided a frame for holding at least one light fixture in a drilling rig arrangement; the frame including a fixed or adjustable frame portion, a light bearing frame portion supported by the frame portion, and at least one lighting fixture attached to the light bearing frame portion.

According to another embodiment, the frame portion is adjustable or fixed and includes at least four support posts for rigidly fixing the adjustable frame portion to the crown, and further includes, between at least two adjacent support posts: a first tubular load bearing member connected to one of the adjacent support posts; a second tubular load bearing member connected to the other of the adjacent support posts; an extendable frame member extending between and into each of the first and second tubular members; such that the first and second tubular load bearing members are moveable with respect to the extendable frame member to thereby adjust a distance between adjacent support posts.

Another embodiment includes a pin extending through the respective tubular load bearing member and the extendable frame member for fixing each of said first and second tubular members with respect to said extendable frame member.

According to another embodiment, the at least four support posts are arranged to form a generally rectangular shape.

According to another embodiment, the corner support posts are rigidly affixed to the crown by a mounting pocket positioned proximate to the bottom end of each of the corner support posts; the mounting pocket being attachable to the body of the crown, proximate to the base of the crown. The lighting system described herein is attached to the crown through these receiving pockets positioned proximate to the bottom of each of the corner support posts, the receiving pockets being attached to the body of the crown, proximate to the base of the crown. Pins which extend through holes in the posts and pockets to accommodate them can also be used to secure the posts in the pockets.

According to another embodiment, the light bearing frame portion comprises an outer structural frame consisting of a plurality of connected beams forming a perimeter around which the at least one light fixture is attached.

According to another embodiment, the light bearing frame portion further includes at least two cross-braces connecting a first side of the outer structural frame to a second side of the outer structural frame; the first and second sides being generally parallel to each other; at least one support brace connecting the at least two cross-braces to each other; and, a locating brace connecting one of the at least one support brace to a third side of the outer structural frame; the third side being generally perpendicular to the first and second sides.

According to another embodiment, there is further provided a second locating brace connecting a second of the at least one support brace to a fourth side of the outer structural frame; the fourth side being generally perpendicular to the first and second sides.

According to another embodiment, the extendable frame members comprises two of the extendable frame members positioned parallel to each other.

According to another embodiment, the light bearing portion further comprises a plurality of lights posts spaced around a perimeter of the outer structural frame; said light holding posts each comprising a first portion for attaching to said outer structural frame and a second portion for holding said lights.

### BRIEF DESCRIPTION OF THE DRAWINGS

Embodiments will now be described, by way of example only, with reference to the attached Figures, wherein:

FIG. 1 is a perspective view of a lighting system mounted on a drilling rig according one embodiment of the invention.

FIG. 2A is a top view of a lighting system as described herein.

FIG. 2B is a side view of a lighting system as described herein.

FIG. 2C is a side view of an embodiment of a light support post, bracket, and lighting fixture as described herein.

FIG. 2D is a perspective view of an embodiment of a light support post, bracket, and lighting fixture as described herein.

FIGS. 3A, 3B and 3C are detailed perspective views of examples of how the lighting system may be connected to the drilling rig.

FIG. 4 is a drawing depicting a drilling rig in general.

### DETAILED DESCRIPTION

The present invention can also relate to slender structures requiring 360 degree lighting.

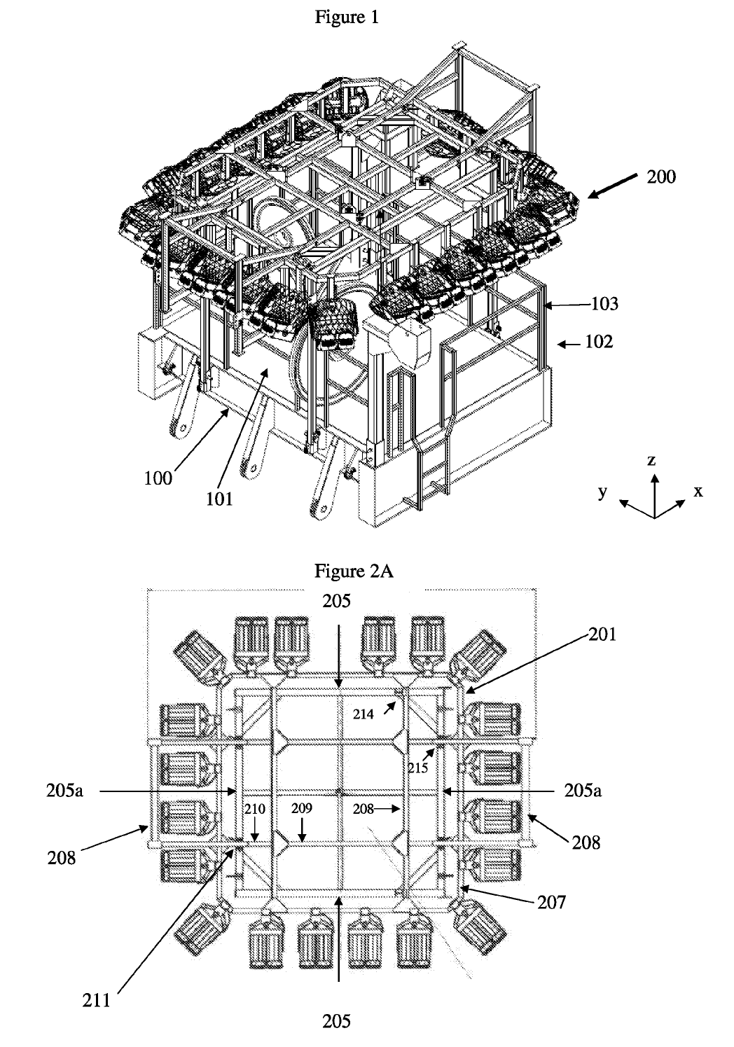

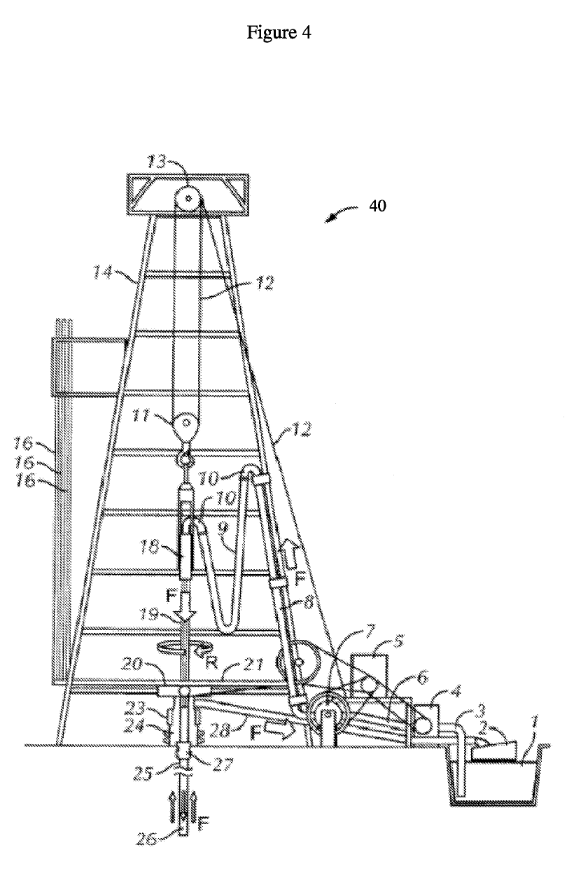

Referring to FIG. 1, a crown 100 of a drilling rig is illustrated in combination with the lighting system 200 described herein. Crown 100 includes a base 101 and an outer frame structure 102 including crown hand rails 103. Various drilling rig functional elements are also illustrated (as described, for example, with respect to FIG. 4), but these are not described herein in detail. The drilling rigs for attachment as described herein are not limited to any particular types of drilling rig functional elements and may be used in various drilling rig applications. The crown 100 as herein illustrated and described is an exemplary crown intended to show those features and elements interacting with the lighting system 200. The lighting system in combination with other crown arrangements known in the art are equally contemplated as described herein.

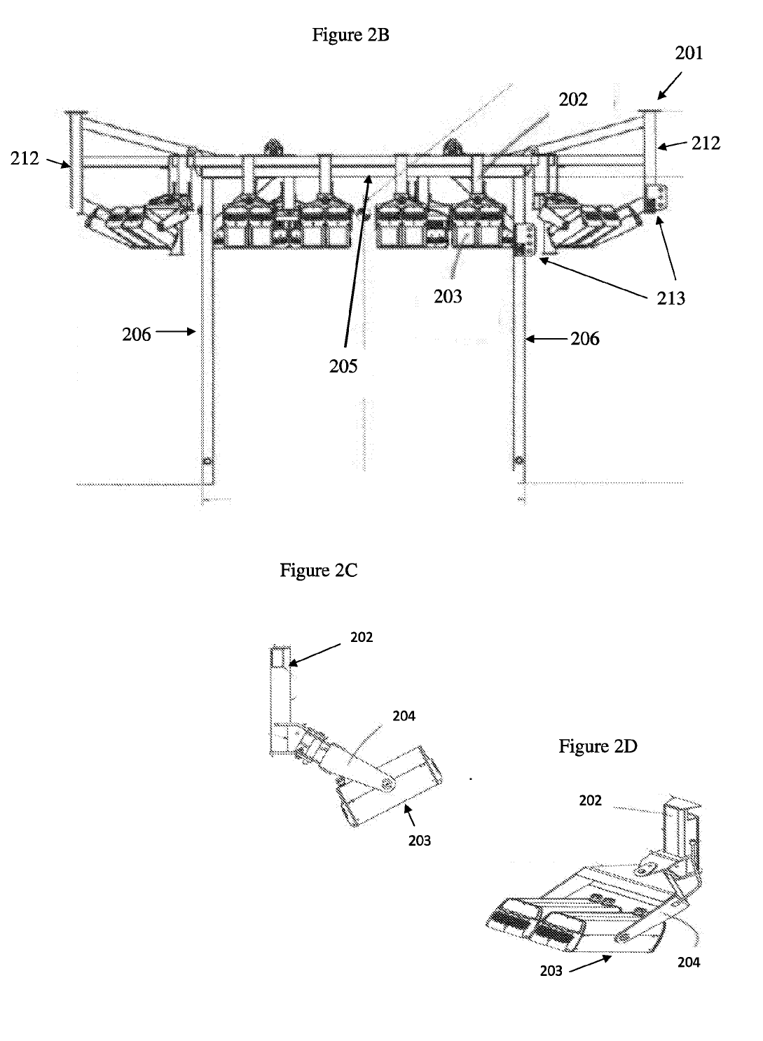

Lighting system 200 generally includes a lighting frame 201 (FIG. 2A) described in more detail herein below, a plurality of light support posts 202 (FIG. 2B), which are arranged around a perimeter of the lighting frame and extending vertically such that one or more light fixtures 203, may be connected to each light support post 202. Light fixture brackets 204 (FIGS. 2C and 2D) are also structured so as to allow each light fixture to tilt up and down and swivel from side to side. The plurality of light fixtures 203 arranged and separated vertically (or horizontally) from each other by their positioning on the light support posts 202 permits for light to be directed in a predetermined region proximate the crown 100 and at a predetermined region encompassing a ground area surrounding the drill rig. That is, one group of lights may be directed towards particular equipment on the drilling rig, while another group may be directed to an area surrounding the drilling rig to provide maximum lighting for personnel working in or around the drilling rig. The light to weight ratio of the light fixture should be as high as possible. For example, about 1000 lumens per pound could typically be used.

Referring again to FIG. 2B, there is shown an exemplary lighting frame including four corner support posts 206 extending from the base of the crown, or from a position proximate the base of the crown. The corner support posts 206 prop up, or otherwise raise the frame above the base of the crown. The upper section of the frame 205 (including 205a in FIG. 2A) supports the light bearing frame 201, which will be described in further detail below. Frame portion 205 can be adjustable or of fixed dimensions. The adjustable frame is provided such that the lighting system can be employed on crowns of various sizes. Providing the adjustable frame portion 205 in a manner independent of the light bearing frame portion 201 permits adjustment of the lighting support frame portion 205 to fit various sized crowns without having to adjust the attachment of the lighting frame 201. In this manner, the lighting system can be readily retrofitted to an existing crown for long term use, or moved from one crown to another where short term use is required.

More particularly, the adjustable or fixed frame portion 205, includes along each of its outer portions, a pair of load bearing members 205 rigidly connected to respective corner support posts 206. Each pair of load bearing members 205 has positioned there between an extendable or fixed frame member 205a. Each of the load bearing members can be tubular, such as tubular steel, and are positioned and otherwise arranged such that the extendable frame member, 205 and/or 205a, extends into the tubular portion of each pair of load bearing members 205 and/or 205a. A pin or other protruding element is arranged on the load bearing members and is adapted to extend through a hole in the extendable frame member (not shown) to thereby fix the positioning of the load bearing members 205 and/or 205a with respect to the extendable frame member. In operation, the load bearing members are slidable along the extendable frame member to a desired point, where they can be locked in place by extending the pin through the hole in the extendable frame member, and though a rear portion of the load bearing member to lock the load bearing member with respect to the extendable frame member. This permits the support portion of the lighting frame to be linearly adjustable in a rectangular manner along the x and y axis shown in FIG. 1. For completeness and clarity, it will be apparent that the frame includes four pairs of the load bearing members described above (205 and 205a), optionally adjustable about four respective extendable frame members. The brackets or extensions 212 shown in FIG. 2B for example, are supports for supporting the frame in an inverted position prior to placement or attachment on or to the drilling rig crown, for example, in transport or shipment. Also shown in FIG. 2B are center of gravity lugs 213, i.e., the design center of gravity for that equipment. There are two on the main or support frame and two on the light frame, primarily for lifting the sections vertically from their horizontal position.

The light bearing frame portion 201 is positioned atop the load bearing members 205 and 205a which provide support for the light bearing frame portion 201. The light bearing frame portion 201 includes an outer structural frame 207 consisting of a plurality of tubular or solid beams forming a perimeter around which the series of lights are to be mounted. The light bearing frame portion 201 further includes cross-braces 208 holding the structure together, where such cross-braces 208 are preferably perpendicular to a side of the lighting system having a longer length, for example perpendicular to the y axis shown in FIG. 1. Connecting the pair of cross-braces are one, and preferably two support braces 209. The support braces 209 are positioned internally to the outer structural frame 207 and each have at a midpoint thereof a locating brace 210 connecting the support brace 209 to one member of said outer structural frame 207. It should also be noted, that while the Figures show a light bearing frame portion or section attached to a load or support bearing frame portion or section, the two portions or sections can of course be constituted as a single piece.

With this arrangement, the adjustable frame portion 205 can be installed in a crown of varying sizes while the light bearing frame portion 207 is held centered upon the lighting frame, resulting in it being centered with respect to the crown on which it is placed. One skilled in the art will appreciate that various addition means for fixing the light bearing portion are also contemplated, including clamps, screws or additional locating pins, e.g. a hook and pin system utilizing locating hooks 214 and guides 215 and pin securement.

Atop the light bearing frame portion 201, spaced along the perimeter of the tubular or solid beams 207 are a plurality of light holding posts 202 (see FIGS. 2C and 2D). The light holding posts are preferably welded to the solid or tubular bears, or otherwise attached, to the beams (although the lights optionally can be attached directly to the beams without the benefit of the posts). The light holding posts generally comprise a portion attaching them to the beams and a portion adapted to hold the light support brackets (204), onto which each of the lights 203 are typically mounted.

Light support posts 202 preferably comprise a vertically extending post onto which a variety of styles of light fixtures 204 may be mounted. As discussed earlier, in a preferred embodiment two light fixtures may be mounted on each light support post 202, spaced vertically or horizontally from each other, thus allowing light to be directed to a plurality of key positions around the drilling rig.

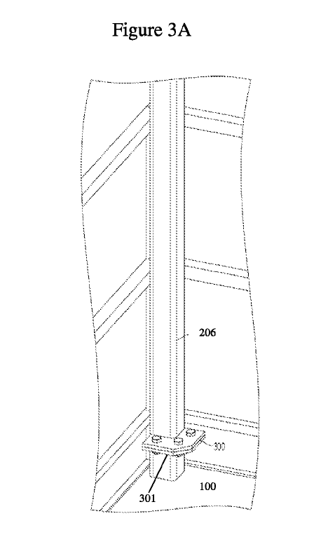

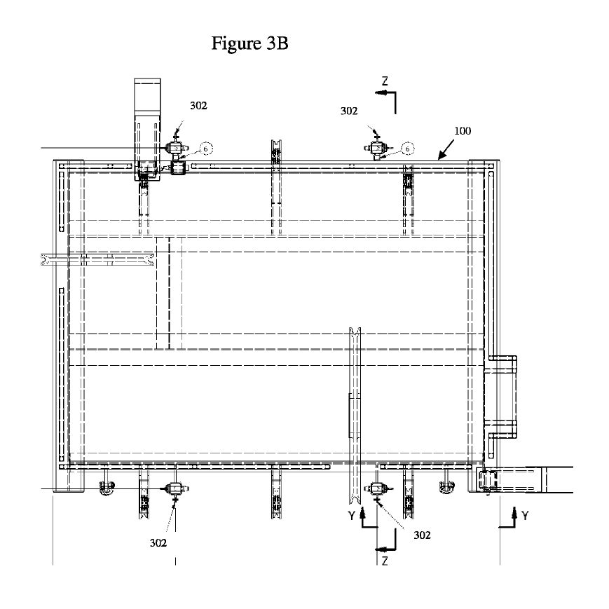

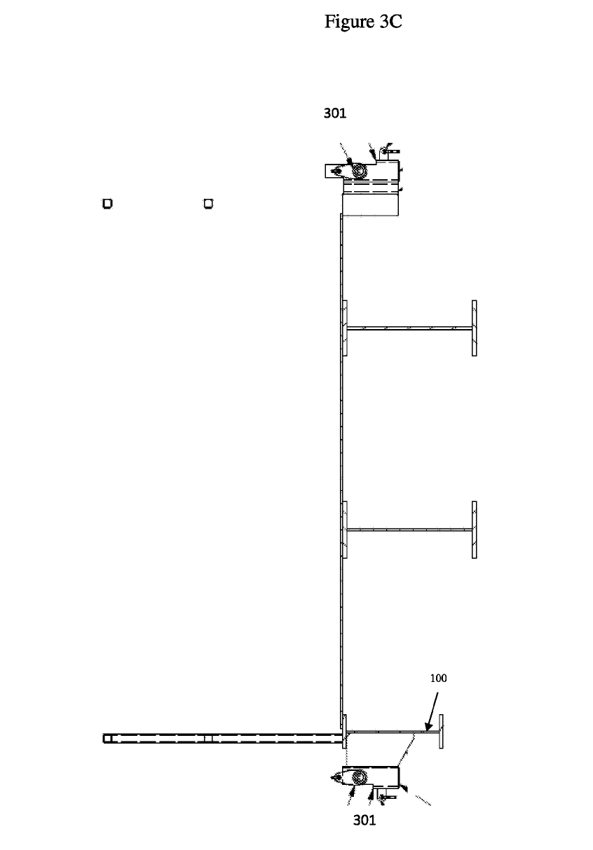

As shown in FIG. 3A, in order to fix the lighting frame with respect to the crown 100, brackets 300 may be provided proximate a bottom portion of each corner support post 206. The brackets 300 may be adapted to be connected to corresponding brackets 301 on the crown 100 or alternatively, to be attached directly to a portion of the crown itself. For example, bolts may fix the brackets 300 directly into a portion of the crown.

Similarly, as shown in FIGS. 3B (top view) and 3C (side view, rotated 90 degrees), in order to fix the lighting frame with respect to the crown 100, mounting pockets 302 may be provided proximate a bottom portion of each corner support post 206. The mounting pockets 302 are welded or bolted the floor section or alternatively, to be attached directly to a portion of the crown itself. For example, bolts may fix the mounting pockets 302 directly into a portion of the crown or the mounting pockets can be welded and affixed permanently. The posts 206 slide into the mounting pockets 302 and are pined in place to secure the unit for use.

The base frame which is attached to the crown is typically made of carbon steel, for example, for strength, especially in cold weather. The light frame is typically made of aluminum, for weight reasons. And while the frame has primarily been described above as adjustable, the pieces described above can also be fixed, for example, where a specific frame is pre-designed for a particular sized crown, rendering the need for the adjustable pieces unnecessary. It should also be noted that the entire unit is built with secondary containment on all the equipment. For example, safety certified nets around each light are secured to lugs on the main frame, safety certified cables are attached to each light and lights are secured to lugs on the main frame, and all pins used to secure the frames together have safety certified cables attached to the frame and mounting pockets. Basically, the frame is set up so that nothing can ever drop off of or fall from the unit, i.e., it is constructed to meet or exceed all industry “Drops standards”—the drop program standard to build equipment ensuring things don't fall or get dropped from heights.

The scope of the claims should not be limited by the preferred embodiments set forth in description of the preferred embodiments or in the examples, but should be given the broadest interpretation consistent with the description as a whole.

1. A lighting system for a drilling rig comprising:
a lighting frame attached to a crown of the drilling rig, wherein the lighting frame includes a fixed or adjustable frame portion attached to the crown of the drilling rig and a light bearing frame portion supported by said frame portion; and
at least one lighting fixture attached to the light bearing frame portion.

2. The lighting system of claim 1, wherein the lighting frame and lighting fixture portions are a single piece.

3. The lighting system according to claim 1, wherein said frame portion is fixed or adjustable and includes at least four support posts for rigidly fixing said frame portion to the crown, and further comprises, between at least two adjacent support posts:
a first tubular load bearing member connected to one of said adjacent support posts;
a second tubular load bearing member connected to the other of said adjacent support posts;
an extendable frame member extending between and into each of said first and second tubular members.

4. The lighting system according to claim 2, wherein the at least four support posts are arranged to form a generally rectangular shape.

5. The lighting system according to claim 1, wherein said light bearing frame portion comprises an outer structural frame consisting of a plurality of connected beams forming a perimeter around which said at least one light fixture is attached.

6. The lighting system according to claim 1, wherein said light bearing frame portion further comprises:
at least two cross-braces connecting a first side of said outer structural frame to a second side of said outer structural frame; said first and second sides being generally parallel to each other;
at least one support brace connecting said at least two cross-braces to each other;
a locating brace connecting one of said at least one support brace to a third side of said outer structural frame; said third side being generally perpendicular to said first and second sides.

7. The lighting system according to claim 6, further comprising a second locating brace connecting a second of said at least one support brace to a fourth side of said outer structural frame; said fourth side being generally perpendicular to said first and second sides.

8. The lighting system according to claim 7, wherein the at least one of said frame members is held in place with guides hooks and pins.

9. The lighting system according to claim 3, wherein the said extendable frame members comprise two of said extendable frame members positioned parallel to each other.

10. The lighting system according to claim 1, wherein said light bearing portion further comprises a plurality of light holding support posts spaced around a perimeter of said outer structural frame; said light holding support posts each comprising a first portion for attaching to said outer structural frame and a second bracket portion for holding the lights.

11. The lighting system according to claim 10, wherein said each of said light holding support posts are adapted to hold at least one light fixture.

12. The lighting system according to claim 11, where said post holds at least two light fixtures spaced vertically or horizontally from each other.

13. The lighting system according to claim 1, wherein said corner support posts are rigidly affixed to said crown by a mounting pocket positioned proximate to the bottom end of each of said corner support posts; said mounting pocket being attached to the body of the crown, proximate to the base of the crown.

14. The lighting system according to claim 1, wherein each lighting fixture can swivel and/or tilt.

15. The lighting system according to claim 1, wherein each lighting fixture is attach directly to the frame.

16. The lighting system of claim 1, additionally including secondary containment.

17. A frame for holding at least one light fixture in a drilling rig arrangement; the frame comprising:
a fixed or adjustable frame portion;
a light bearing frame portion supported by said frame portion;
at least one light support post attached to said light bearing frame portion for holding a lighting fixture; and,
at least one lighting fixture attached to each said light support posts.

18. The frame according to claim 17, wherein said frame portion is adjustable and includes at least four support posts for rigidly fixing said adjustable frame portion to the crown, and further comprises, between at least two adjacent support posts:
a first tubular load bearing member connected to one of said adjacent support posts;
a second tubular load bearing member connected to the other of said adjacent support posts;
an extendable frame member extending between and into each of said first and second tubular members;
such that said first and second tubular load bearing members are moveable with respect to said extendable frame member to thereby adjust a distance between adjacent support posts.

19. The frame according to claim 18, including at least one pin extending through said respective tubular load bearing member and said extendable frame member for fixing each of said first and second tubular members with respect to said extendable frame member.

20. The frame according to claim 18 wherein said at least four support posts are arranged to form a generally rectangular shape.

21. The frame according to claim 18, wherein said light bearing frame portion comprises an outer structural frame consisting of a plurality of connected beams forming a perimeter around which said at least one light fixture is attached.

22. The frame according to claim 18, wherein said light bearing frame portion further comprises:
at least two cross-braces connecting a first side of said outer structural frame to a second side of said outer structural frame; said first and second sides being generally parallel to each other;
at least one support brace connecting said at least two cross-braces to each other;
a locating brace connecting one of said at least one support brace to a third side of said outer structural frame; said third side being generally perpendicular to said first and second sides.

23. The frame according to claim 22, further comprising a second locating brace connecting a second of said at least one support brace to a fourth side of said outer structural frame; said fourth side being generally perpendicular to said first and second sides.

24. The frame according to claim 18, wherein at least two of said extendable frame members positioned parallel to each other.

25. The frame according to claim 18, wherein said light bearing portion further comprises a plurality of light support posts spaced around a perimeter of said outer structural frame; each support post comprising a first portion for attaching to said outer structural frame and a second portion for holding said light support posts.

26. The lighting system according to claim 18, wherein each lighting fixture can swivel and/or tilt.

27. The lighting system of claim 17, additionally including secondary containment.
